(19) United States
(12) Patent Application Publication
(10) Pub. No.: US 2025/0292703 A1
(43) Pub. Date: Sep. 18, 2025

(54) VETERINARY NASAL TRAINING DEVICE

(71) Applicant: Brooke Ann Davis, Wheeling, IL (US)

(72) Inventor: Brooke Ann Davis, Wheeling, IL (US)

(21) Appl. No.: 18/934,820

(22) Filed: Nov. 1, 2024

Related U.S. Application Data
(60) Provisional application No. 63/565,050, filed on Mar. 14, 2024.

(51) Int. Cl. G09B 23/30

(52) U.S. Cl. CPC G09B 23/30

(57) ABSTRACT

An animal suturing training device includes a snout portion constructed in the form of an animal snout. The animal suturing training device also includes a nose portion that includes nostrils and nasal passages coupled to the animal snout. The nasal nostrils and nasal passages are constructed to resemble an anatomical functional animal nasal airway.

### CROSS-REFERENCE TO RELATED APPLICATIONS

This application claims the benefit of priority of U.S. provisional application No. 63/565,050, filed Mar. 14, 2024, titled “NASAL TRAINING DEVICE” the entire contents of which are herein incorporated by reference.

### FIELD

The present disclosure relates to devices for veterinary medical training, and more particularly, to a device for training a nurse or doctor to securely affix nasogastric or nasal oxygen catheters in a safe manner.

### BACKGROUND

Veterinary nurses or veterinarians can be required to secure nasal tubing via sutures to provide enteral feeding, suction of gastric fluid, or oxygen administration to canines and other animals. To reduce pain and complications, veterinary nurses and veterinarians train at suturing, but there are currently no non-perishable or reusable nasal training aids for practicing suturing. Currently, veterinary nurses and veterinarians must rely on cadavers to get anatomically correct practice, but cadavers are not always readily available or practical.

As can be seen, there is a need for a reusable nasal suture training device that can aid in skill development for veterinary nurses and veterinarians.

### SUMMARY

In one aspect of the present disclosure, an animal suturing training device includes a snout portion constructed in the form of an animal snout. The animal suturing training device also includes a nose portion including nostrils and nasal passages coupled to the animal snout. The nasal nostrils and nasal passages are constructed to resemble an anatomical functional animal nasal airway.

In another aspect of the present disclosure, a method of making a training device includes forming an initial mold of an animal snout from a first material. The method includes forming a final mold of an animal snout by placing a second material over the initial mold. Further, the method includes forming the training device by placing a third material into the final mold.

### BRIEF DESCRIPTION OF THE DRAWINGS

FIG. 1 is a diagram of an embodiment of a nasal suture training device, according to aspects of the present disclosure;

FIG. 2 is another diagram of the nasal suture training device of FIG. 1, according to aspects of the present disclosure; and

FIG. 3 is a method of making a nasal suture training device, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As stated above, there are currently no anatomical canine nasal training aids where tubing can be passed and sutured to the aid in a repeatable manner. Nasogastric tubes in dogs and cats are becoming much more prevalent as critical care for companion animals expands. Inappropriately securing nasogastric tubes (most often with suture) can result in patient pain and suffering, because animals constantly sneeze, gag, or paw at their face. Failure to secure a tube can subject an animal to multiple nasogastric tube replacements, which would subject the animal to multiple episodes of stress and restraint or possibly harmful sedation drugs, along with increased exposure to x-rays taken to confirm the placement of these tubes. This is time-consuming and costly for the veterinary practice and the pet owners. If a nasogastric tube is not secured adequately, it can also become dislodged, allowing a patient to chew on the tube and cause foreign material to be ingested, or if it becomes dislodged during a constant drip feeding of liquid diet, the patient can aspirate the liquid diet into their lungs and get aspiration pneumonia which is often deadly.

Broadly, an embodiment of the present disclosure provides a veterinary nasal training device, including a nose part, formed of a reusable material, which can allow for safe training/teaching of nasal tube placements. Because the nose part is functional and mimics the look and feel of a real nose, the veterinary nasal training device allows for safe training/teaching of nasal tube placements. This decreases the possible pain and suffering a canine patient may go through as well as increases patient safety and mortality, as poorly secured nasogastric tubes can lead to accidental patient death.

The veterinary nasal training device can be used to teach and train veterinary medical professionals throughout privately owned, corporation owned veterinary practices as well as veterinary and veterinary technology schools and universities around the world without the need and burden of cadavers or live animals potentially harmed for practice. The veterinary nasal training device can be a light weight, small, portable, and a potentially inexpensive alternative to help teach veterinary medical professionals.

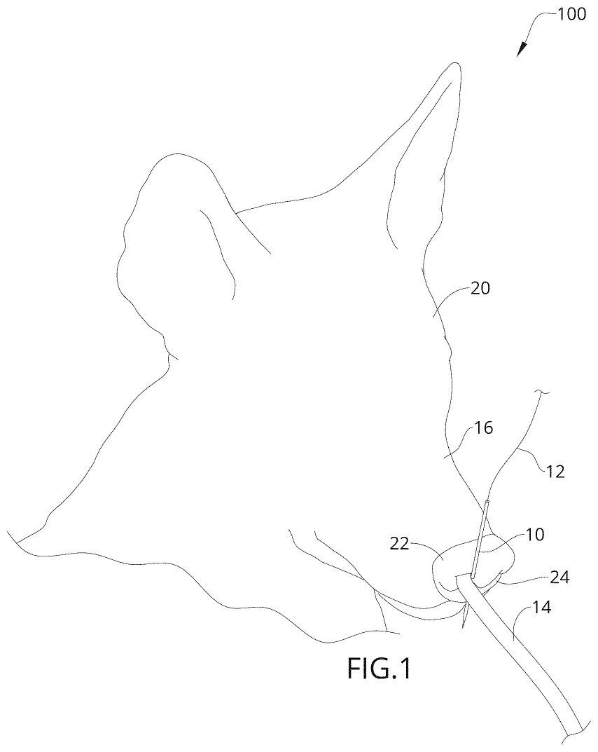

Referring now to FIGS. 1-3, FIG. 1 illustrates an embodiment of a veterinary nasal training device 100, according to aspects of the present disclosure. While FIG. 1 illustrates examples of components of the veterinary surgical training device 100, additional components can be added and existing components can be removed and/or modified.

The veterinary nasal training device 100 is constructed to resemble an animal, for example, a canine, and includes a head portion 20 and snout 16. The snout 16 can include a nose portion 22 with nostril(s) 24 providing access to a nasal airway. The nose portion 22 and nostrils 24 to the nasal airway can be constructed having the same structure and form as a real live animal, e.g., canine, nasal airway. While the head portion 20 and the snout 16 are constructed to resemble a canine and canine anatomy, it is envisioned that any animal can be modeled without departing from the scope of the disclosure. Additionally, while it is illustrated that the snout 16 is coupled to the head portion 20, in some embodiments, the veterinary nasal training device 100 may only include the snout 16 and/or nose portion 22.

In some embodiments, the head portion 20 can also include anatomically correct and functional anatomy such as ear canals, nasal sinuses, and passages, as well as mouth, throat, and tracheal openings, epiglottis, arytenoid cartilages, and functional jugular vein apparatus.

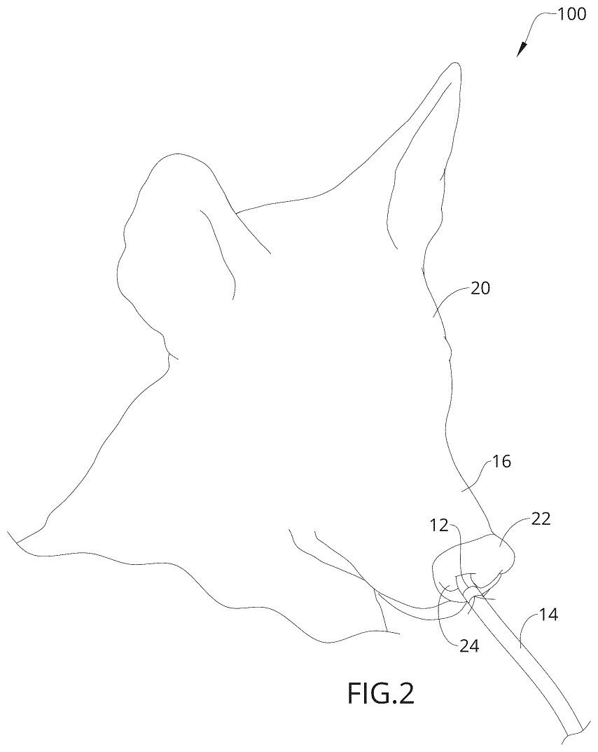

In embodiments, a user can perform nasal related procedures using the veterinary surgical training device 100. As illustrated in FIGS. 1 and 2, the nostril(s) 24 can be adapted to accept tube 14. The user can then perform suturing using a suturing kit which includes a needle 10 and thread 12. For example, the needle 10 and thread 12 can be inserted into nostril 24 or nose 22 which securely affixes tube 14 inside an animal's nose, as shown in FIG. 2 where the tube 14 is securely affixed thereto. As such, the veterinary nasal training device 100 provides an easy and convenient tool for veterinary professionals to perfect the task of adequately securing nasogastric or nasal oxygen tubing in a safe, non-harmful manner.

In embodiments, the veterinary nasal training device 100 can be formed from durable material that simulates the resistance of flesh, which can provide an accurate simulation to a veterinary professional of the force necessary to perform suturing. In an embodiment, the veterinary nasal training device 100 can be formed from foam clay.

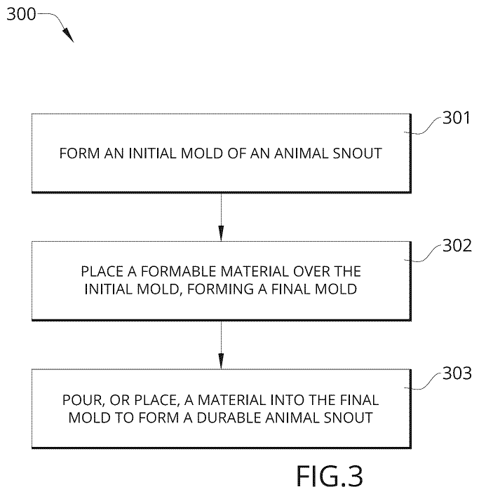

FIG. 3 illustrates a method 300 for making the veterinary nasal training device 100, according to aspects of the present disclosure. While FIG. 3 illustrates examples of steps or stages of the method 300, additional steps or stages can be added and existing steps or stage can be removed, modified, and/or reordered.

As illustrated, at step 302, an initial mold of an animal snout including the nose portion and nostrils, which are anatomically correct, can be made from a formable material, such as clay. It is envisioned that any animal snout can be formed and not depart from the scope of the disclosure. At step 304, a mold of a canine snout can be made placing a formable material over the initial mold. In an embodiment, silicon can be poured over the initial mold to form a final mold, suitable for mass production. At step 306, a material can be poured, or placed, in the final mold to form device 100. In an embodiment, foam clay can be used to form device 100. In some embodiments, the head portion can be formed with the snout. In some embodiments, the snout can be formed separately and then affixed to the head portion.

For example, modeling clay and dog doll nose (as well as clay sculpting tools for texture) are used to sculpt the canine snout form. After sculpting, the sculpted snout is allowed time to fully air dry for 24-48 hours. A casing/housing is constructed around the clay model with plastic sheets and hot glue. Liquid silicone rubber is mixed according to manufacture instructions, poured into the casing/housing, and allowed to air dry/solidify for 24 hours. The clay model is removed, and the silicone mold is cleaned with warm water. Once dry, foam clay is pressed into the mold layer by layer and then placed into a regular household freezer for 24 hours. The foam clay model is then removed and allowed to air dry for 24-48 hours. Once dry, a leather die punch hollow eyelet hole tool is used to create nasal holes/openings. An owl tool and small scissors are also used to assist. The small scissors are used to create the alar folds of the nose.

Alternatively, silicone could be used to pour into a silicone mold the way real/life like baby dolls are made or silicone human parts for teaching/training medical students or prosthetics. This method could also be used for mass production. The silicone in silicone method may last much longer and be able to be sutured/needle pierced many more times as well as improve durability. This may also make the completed model even more life-like. The nasal holes and folds may need to be formed in the original model or during the silicone setting if not using foam clay. Otherwise, the owl tool, leather die punch tool and possibly scissors would be necessary.

The veterinary surgical training device 100 can be used to teach and train veterinary medical professionals throughout privately owned corporation-owned veterinary practices as well as veterinary and veterinary technology schools and universities around the world without the need and burden of cadavers or live animals harmed by practice. It would be a lightweight, small, portable, and potentially inexpensive alternative to help teach veterinary medical professionals. The veterinary surgical training device 100 can also be used to teach nasal tubing suturing skills at local, national, or international continuing education conferences. Veterinary professionals can practice or learn this very important and necessary skill without the harm of any live animal or having to obtain and maintain perishable cadavers. The veterinary surgical training device 100 can allow people to practice these skills and make mistakes without harming a pet, which will avoid needless accidental veterinary patient death and very costly legal repercussions for veterinary practices around the world.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. An animal nasal suturing training device, comprising:
a snout portion constructed in the form of an animal snout; and
a nose portion comprising nostrils and nasal passages coupled to the animal snout, wherein the nasal nostrils and nasal passages are constructed to resemble an anatomical functional animal nasal airway.

2. A device of claim 1, the device further comprising:
a head portion constructed to resemble an animal head, wherein the snout portion is coupled to the head portion.

3. The device of claim 2, wherein the head portion includes at least one additional anatomical feature.

4. The device of claim 1, wherein the nose portion and the head portion are constructed of silicone.

5. A method of making a training device, the method comprising:
forming an initial mold of an animal snout from a first material;
forming a final mold of an animal snout by placing a second material over the initial mold; and
forming the training device by placing a third material into the final mold.

6. The method of claim 5, wherein the first material is clay, the second material is silicone, and the third material is foam clay.
